(19) United States
(12) Patent Application Publication
(10) Pub. No.: US 2026/0212085 A1
(43) Pub. Date: Jul. 23, 2026

(54) INFORMATION PROCESSING APPARATUS, INFORMATION PROCESSING METHOD, AND GENERATION METHOD

(71) Applicant: HONDA MOTOR CO.,LTD., Tokyo (JP)

(72) Inventor: Qianlong WANG, Tokyo (JP)

(21) Appl. No.: 19/430,271

(22) Filed: Feb. 4, 2026

(30) Foreign Application Priority Data
Jan. 23, 2025 (JP) 2025-009539

(51) Int. Cl. G06F 30/27; G06F 113/04

(52) U.S. Cl. CPC G06F 30/27; G06F 2113/04

(57) ABSTRACT

An information processing apparatus acquires prediction weather information at a predefined time point; and predicts, based on information output by a prediction model that takes the prediction weather information as input and outputs at least an amount of energy at the predefined time point, the amount of energy at the predefined time point. The prediction model is: (i) constructed by performing machine learning which uses, with a magnitude which varies, the performance weather information and the performance amount-of-energy information indicating a performance value of an amount of energy at each of the plurality of time points, or (ii) constructed, by performing machine learning which uses the performance weather information and the performance amount-of-energy information, to further output an index value on distribution of energy at the predefined time point.

The contents of the following patent application(s) are incorporated herein by reference:
NO. 2025-009539 filed in JP on Jan. 23, 2025.

### BACKGROUND

### 1. Technical Field

The present invention relates to an information processing apparatus, an information processing method, and a generation method.

### 2. Related Art

Patent document 1 discloses a technique to use electric power accumulated in a battery of a vehicle, outside the vehicle.

### RELATED ART DOCUMENTS

### Patent Documents

Patent Document 1: International Publication No. 2024/070109

### BRIEF DESCRIPTION OF THE DRAWINGS

FIG. 1 conceptually illustrates a utilization form of a system 5 in an embodiment.

FIG. 2 illustrates an example of a system configuration of a power control apparatus 40.

FIG. 3 illustrates an example of a system configuration of a vehicle management apparatus 60.

FIG. 4 illustrates an example of a system configuration of an integrated management apparatus 50.

FIG. 5 illustrates an execution sequence of processing in a method performed by the power control apparatus 40, the integrated management apparatus 50, and the vehicle management apparatus 60.

FIG. 6 schematically illustrates an overview of processing performed by the vehicle management apparatus 60, the integrated management apparatus 50 and the power control apparatus 40.

FIG. 7 schematically illustrates an example timetable for a usage of a vehicle 10 based on an operation plan.

FIG. 8 schematically illustrates an example timetable for the usage of the vehicle 10 decided due to arbitration of an electricity plan and the operation plan.

FIG. 9 illustrates a graph describing transitions of an amount of purchased electric power for the office 30 over one day.

FIG. 10 conceptually illustrates processing in which a model generation unit 460 generates a prediction model.

FIG. 11 illustrates a diagram for describing information that is used to generate a first prediction model.

FIG. 12 is a flowchart for processing in which the power control apparatus 40 generates the prediction model.

FIG. 13 is a flowchart for processing for deciding the usage plan of the vehicle in the system 5.

FIG. 14 conceptually illustrates another processing in which the model generation unit 460 generates the prediction model.

FIG. 15 illustrates a diagram for describing information that is used to generate a second prediction model.

FIG. 16 illustrates a diagram for describing information output by the second prediction model.

FIG. 17 is a flowchart for another processing for deciding the usage plan of the vehicle 10 in the system 5 by using the second prediction model.

FIG. 18 illustrates an example of a computer 2000 in which a plurality of embodiments of the present invention may be entirely or partially embodied.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solutions of the invention.

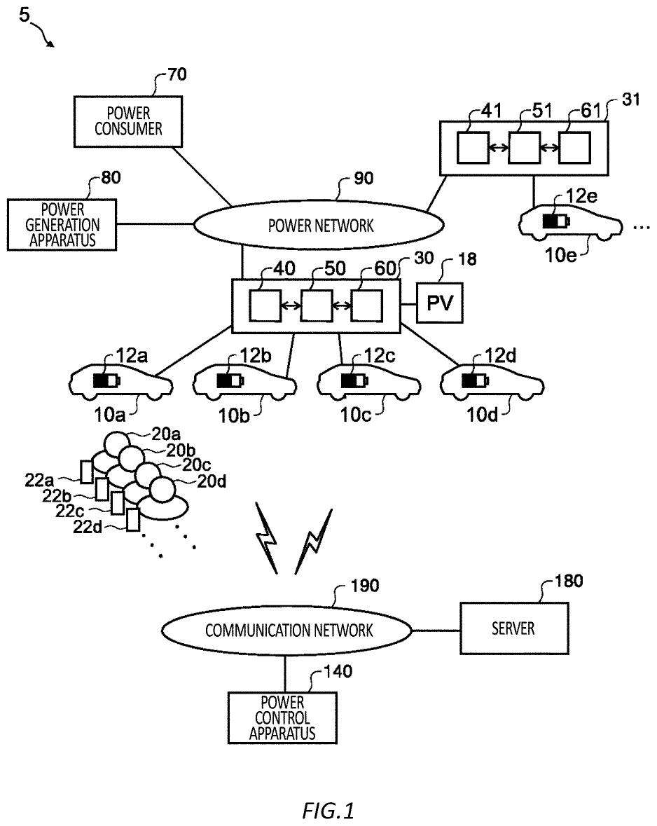

FIG. 1 conceptually illustrates a utilization form of a system 5 in an embodiment. The system 5 includes: a power generation apparatus 80; a plurality of vehicles including a vehicle 10a, a vehicle 10b, a vehicle 10c, a vehicle 10d and a vehicle 10e; a plurality of terminals including a terminal 22a, a terminal 22b, a terminal 22c and a terminal 22d; a power control apparatus 40 and a power control apparatus 41; an integrated management apparatus 50 and an integrated management apparatus 51; a vehicle management apparatus 60 and a vehicle management apparatus 61; a power control apparatus 140; and a server 180.

A power consumer 70 and the power generation apparatus 80 are connected to a power network 90. The electric power generated by the power generation apparatus 80 can be supplied to the power consumer 70 through the power network 90. The power network 90 is a power system, for example.

The vehicle 10a, the vehicle 10b, the vehicle 10c, the vehicle 10d, and the vehicle 10e are electric vehicles that respectively include a battery 12a, a battery 12b, a battery 12c, a battery 12d, and a battery 12e, in which driving electric power for the vehicle to drive is accumulated. The electric vehicle is an example of an electrically-driven vehicle. The electric vehicle is an example of a movable body. In the present embodiment, in particular, the vehicle 10a, the vehicle 10b, the vehicle 10c, and the vehicle 10d may be collectively referred to as a “vehicle 10”, and the battery 12a, the battery 12b, the battery 12c, and the battery 12d may be collectively referred to as a “battery 12”. The vehicle 10 is an example of an “energy accumulation apparatus”. The battery 12 is an example of an “energy accumulation unit”.

The terminal 22a is a terminal that a user 20a uses; and the terminal 22b is a terminal that a user 20b uses; and the terminal 22c is a terminal that a user 20c uses; and the terminal 22d is a terminal that a user 20d uses. In the present embodiment, the terminal 22a, the terminal 22b, the terminal 22c, and the terminal 22d may be collectively referred to as a “terminal 22”. The user 20a, the user 20b, the user 20c, and the user 20d may be collectively referred to as a “user 20”. The user 20 is a user of the vehicle 10. The vehicle 10 is an example of a “reservation target”.

The vehicle 10 is deployed in an office 30. The office 30 functions as a home point for parking the vehicle 10. In the present embodiment, the office 30 may be referred to as “headquarters”. The vehicle 10 may be, for example, a vehicle for commercial use or may be a vehicle for carrying shipments such as products handled by the office 30. Electric power is supplied to the office 30 through the power network 90.

The power control apparatus 40, the integrated management apparatus 50, and the vehicle management apparatus 60 are provided in the office 30. The vehicle 10 is provided to be able to communicate with the vehicle management apparatus 60 through a mobile communication network or the like. The office 30 has a local power network in the office, and electric power exchange with the battery 12 included in the vehicle 10 can be performed through a charge-and-discharge apparatus provided in the office 30 and the power network in the office 30. That is, the vehicle 10 can be used for energy management in the office 30. The battery 12 included in the vehicle 10 can perform the electric power exchange with the power network 90 through a power network in the office 30. The power control apparatus 40 controls charging and discharging of the vehicle 10 deployed in the office 30 so as to at least satisfy a power demand in the office 30.

A power generation apparatus 18 is provided in the office 30. The power generation apparatus 18 generates electric power from renewable energy. Specifically, the power generation apparatus 18 generates electric power from natural energy. Examples of natural energy may include energy obtained from natural phenomena, such as solar, geothermal, wind, and tidal flow. More specifically, the power generation apparatus 18 generates electric power from at least one of solar light, wind, solar heat, ambient heat, or other heat existing in nature, and tidal flow. The electric power generated by the power generation apparatus 18 is, through the power network in the office 30, supplied to and consumed by an electrical load in the office 30, which is a power consumer. The electric power generated by the power generation apparatus 18 can be used to charge the battery 12 included in the vehicle 10 through the power network in the office 30 and the charge-and-discharge apparatus provided in the office 30. The electric power generated by the power generation apparatus 18 can be used for performing electric power exchange with the power network 90 through the power network in the office 30.

The power control apparatus 40, the integrated management apparatus 50, and the vehicle management apparatus 60 are managed, for example, in the office 30. The power control apparatus 40 and the integrated management apparatus 50 are provided to be able to communicate with each other through a communication line. The integrated management apparatus 50 and the vehicle management apparatus 60 are provided to be able to communicate with each other through a communication line. The integrated management apparatus 50 and the vehicle management apparatus 60 may be provided outside the office 30. The integrated management apparatus 50 and the vehicle management apparatus 60 may be provided to be able to communicate with each other through a communication line such as the Internet. One or both of the integrated management apparatus 50 and the vehicle management apparatus 60 may be embodied as a server, such as a cloud server.

The user 20 makes a usage reservation of the vehicle 10 by using the terminal 22. For example, the user 20 inputs a time of departure from the office 30, a destination, and a time of return to the office 30, into the terminal 22. The terminal 22 transmits reservation information to the vehicle management apparatus 60 through a communication network 190.

The vehicle management apparatus 60 decides the time of departure and the time of return of the vehicle 10 from/to the office 30 based on the reservation information received from the terminal 22. The integrated management apparatus 50 performs arbitration for adjusting the time of departure and the time of return of the vehicle 10 from/to the office 30 so as to meet a power demand in the office 30. For example, the integrated management apparatus 50 performs arbitration for adjusting the time of departure and the time of return of the vehicle 10 from/to the office 30 so that peak shaving of the power demand in the office 30 can be performed. The vehicle management apparatus 60 manages the vehicle 10 based on the schedule of the vehicle 10 adjusted by the integrated management apparatus 50. The power control apparatus 40 controls charging and discharging of the battery 12 included in the vehicle 10 based on the schedule of the vehicle 10 adjusted by the integrated management apparatus 50.

The vehicle 10e is deployed in an office 31. The office 31 functions as a home point for parking the vehicle 10e. Similar to the vehicle 10, the vehicle 10e may be a vehicle for commercial use or may be a vehicle for carrying shipments such as products handled by the office 31. Electric power is supplied to the office 31 through the power network 90. The power control apparatus 41, the integrated management apparatus 51, and the vehicle management apparatus 61 are provided in the office 31.

In the office 31, the power control apparatus 41, the integrated management apparatus 51, and the vehicle management apparatus 61 correspond to the power control apparatus 40, the integrated management apparatus 50, and the vehicle management apparatus 60. The power control apparatus 41, the integrated management apparatus 51, and the vehicle management apparatus 61 perform control similar to that of the power control apparatus 40, the integrated management apparatus 50, and the vehicle management apparatus 60 except that a control target and/or a management target is the office 31 and/or the vehicle 10e. For this reason, the description of the control related to the power control apparatus 41, the integrated management apparatus 51, the vehicle management apparatus 61, and the vehicle 10e is omitted.

The power control apparatus 140 communicates with the power control apparatus 40 and the power control apparatus 41 through a communication network 190, and supervises overall power control in the office 30 and the office 31. For example, the power control apparatus 140 collects information related to power supply and demand from the power control apparatus 40 and the power control apparatus 41, and performs adjustment of overall power supply and demand including electricity transaction with the power network 90, so that the power control apparatus 40 and the power control apparatus 41 are caused to perform control so as to minimize the total electricity cost of the office 30 and the office 31.

The power control apparatus 140 is connected to the server 180 through the communication network 190. The server 180 is, for example, a server used by a power aggregator. The server 180 conducts electricity transactions in an electricity market. The power control apparatus 140 can provide the server 180 with power resources that are held by aggregating the vehicles deployed in the office 30 and the office 31. The power control apparatuses 40 and 41 control charging and discharging of the battery of each of the vehicles deployed in the office 30 and the office 31, and the power control apparatus 140 provides electric power agreed by the server 180. For example, according to the demand from the server 180, the power control apparatus 140 controls charging and discharging of the battery 12 by the power control apparatus 40 and the power control apparatus 41, and provides electric power corresponding to the demand.

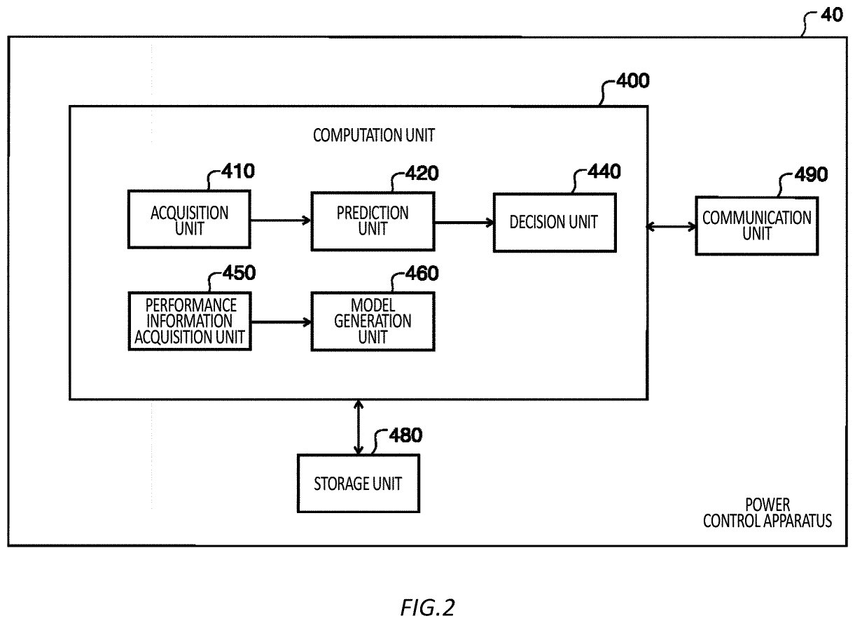

The control mainly related to the office 30 will be described with reference to FIG. 2 to FIG. 17 or the like. Specifically, control related to the power control apparatus 40, the integrated management apparatus 50, the vehicle management apparatus 60, and the vehicle 10 will be described. However, the control related to the office 30 can be applied to the control related to the office 31.

FIG. 2 illustrates an example of a system configuration of the power control apparatus 40. The power control apparatus 40 includes a computation unit 400, a storage unit 480, and a communication unit 490. The power control apparatus 40 is an example of an information processing apparatus which performs information processing for predicting an amount of energy to be generated and/or consumed in connection with weather.

The computation unit 400 performs control of the communication unit 490. The communication unit 490 is responsible for communication with the integrated management apparatus 50 or the like. The computation unit 400 is embodied as an arithmetic processing unit including a processor. Each storage unit 480 is embodied to include a non-volatile storage medium. The computation unit 400 performs processing by using the information stored in the storage unit 480. The computation unit 400 may be embodied as a microcomputer including a CPU, a ROM, a RAM, an I/O, a bus, and the like. The power control apparatus 40 may be embodied as a computer.

In the present embodiment, the power control apparatus 40 shall be embodied as a single computer. However, in another embodiment, the power control apparatus 40 may be embodied as a plurality of computers. At least some of the functions of the power control apparatus 40 may be implemented by one or more servers, such as a cloud server.

The computation unit 400 includes an acquisition unit 410, a prediction unit 420, a decision unit 440, a performance information acquisition unit 450, and a model generation unit 460. The acquisition unit 410 acquires prediction weather information at a predefined time point. Examples of the prediction weather information may include weather type, temperature, wind speed, humidity, atmospheric pressure, infrared index, ultraviolet index, and the like. The acquisition unit 410 may acquire the prediction weather information from an external server which provides weather information in the future.

The prediction unit 420 predicts, based on information output by a prediction model that takes the prediction weather information as input, and outputs at least an amount of energy at the predefined time point, the amount of energy at the predefined time point. The amount of energy that the prediction model outputs is an amount of energy that is generated and/or consumed in connection with weather. The amount of energy that the prediction unit 420 predicts is an amount of electric power to be generated by the power generation apparatus 18, an amount of electric power to be consumed by a power consumer who is to consume the electric power generated by the power generation apparatus 18, or, an amount of electric power calculated based on at least one of the amount of electric power to be generated by the power generation apparatus 18 or the amount of electric power to be consumed by the power consumer.

Examples of the amount of electric power calculated based on at least one of the amount of electric power to be generated by the power generation apparatus 18 or the amount of electric power to be consumed by the power consumer may include an amount of electric power calculated by subtracting the amount of electric power to be generated by the power generation apparatus 18 from the amount of electric power to be consumed by the power consumer. In the present embodiment, the amount of electric power calculated by subtracting the amount of electric power to be generated by the power generation apparatus 18 from the amount of electric power to be consumed by the power consumer needs to be supplied to the office 30 from an outside of the office 30. Assuming that no power is supplied from the vehicle 10 to the office 30, the amount of electric power calculated by subtracting the amount of electric power to be generated from the amount of electric power to be consumed needs to be purchased through the power network 90. Therefore, in the present embodiment, the amount of electric power calculated by subtracting the amount of electric power to be generated from the amount of electric power to be consumed may be referred to as an “amount of purchased electric power”.

The prediction model is constructed based on a relationship between performance weather information indicating a performance value of weather at each of a plurality of past time points and performance amount-of-energy information indicating a performance value of an amount of energy at each of the plurality of time points. Specifically, the prediction model is: (i) constructed by performing machine learning which uses the performance weather information and the performance amount-of-energy information with a magnitude which varies depending on whether a difference amount between an amount of energy output by the prediction model when the performance weather information is input into the prediction model and the performance value of an amount of energy corresponding to the performance value of weather indicated by the performance weather information is larger or smaller than a predefined value, or (ii) constructed, by performing machine learning which uses the performance weather information and the performance amount-of-energy information, to further output an index value on distribution of energy at the predefined time point.

In the present embodiment, the prediction model described above which is (i) constructed by performing machine learning which uses the performance weather information and the performance amount-of-energy information with a magnitude which varies depending on whether a difference amount between an amount of energy output by the prediction model when the performance weather information is input into the prediction model and the performance value of the amount of energy corresponding to the performance value of weather indicated by the performance weather information is larger or smaller than a predefined value, may be specifically referred to as a “first prediction model”. In the present embodiment, the prediction model which is (ii) constructed, by performing machine learning which uses the performance weather information and the performance amount-of-energy information, to further output the index value on distribution of energy at the predefined time point, may be specifically referred to as a “second prediction model”. In the present embodiment, the first prediction model and the second prediction model may be collectively referred to as the “prediction model”.

The first prediction model is constructed by optimizing a goal function value which varies depending on whether the difference amount is larger or smaller than a predefined value. Specifically, the first prediction model is constructed by optimizing a goal function value which varies depending on whether the difference amount is positive or negative.

The second prediction model is constructed, by performing machine learning which uses the performance weather information and the performance amount-of-energy information and of which goal function is a probability distribution function, such that the prediction model further outputs the index value on distribution. The probability distribution function includes a parameter corresponding to the amount of energy at the predefined time point and a parameter corresponding to the index value on distribution. As an example, the parameter corresponding to the amount of energy at the predefined time point included in the probability distribution function may indicate an average value of the amount of energy. The parameter corresponding to the index value on distribution included in the probability distribution function may indicate a standard deviation.

The prediction model is constructed based on a relationship between the performance weather information at an installation location of a particular power generation apparatus and the performance amount-of-energy information on the particular power generation apparatus.

The amount of energy at the predefined time point output by the prediction model is an amount of electric power to be generated by the particular power generation apparatus, an amount of electric power to be consumed by a power consumer who is to consume the electric power generated by the particular power generation apparatus, or, an amount of electric power calculated based on at least one of the amount of electric power to be generated or the amount of electric power to be consumed.

The prediction weather information may include at least one of temperature, humidity, wind speed, weather type, infrared intensity, or atmospheric pressure. The prediction model may be a model into which at least one of date, time or day of week is further input.

The decision unit 440 decides, based on the amount of energy at the predefined time point predicted by the prediction unit 420, a usage schedule of the vehicle 10. For example, the decision unit 440 may decide, based on the amount of energy at the predefined time point predicted by the prediction unit 420, the vehicle 10 of which battery 12 is used for power supply to the office 30. The decision unit 440 may decide, based on the amount of energy at the predefined time point predicted by the prediction unit 420, a time period for which power supply is performed from the battery 12 to the office 30.

The decision unit 440 may decide, based on a difference between the amount of energy at the predefined time point predicted by the prediction unit 420 and a predefined goal amount of energy, the usage schedule. For example, the decision unit 440 may decide, based on a difference between an amount of purchased electric power at the predefined time point predicted by the prediction unit 420 and a predefined amount of electric power as a goal value of the amount of purchased electric power, the usage schedule of the vehicle 10.

The communication unit 490 transmits, as an electricity plan, information indicating the usage schedule of the vehicle 10 decided by the decision unit 440 to the integrated management apparatus 50.

Next, a configuration to generate a prediction model for predicting the amount of energy to be generated and/or consumed in connection with weather by the power control apparatus 40 will be described.

The performance information acquisition unit 450 acquires performance weather information, which is a performance value of weather at each of a plurality of past time points and the performance amount-of-energy information, which is a performance value of the amount of energy at each of the plurality of time points. For example, the performance information acquisition unit 450 acquires, through the communication network 190, the performance weather information from an external server which provides weather information. The performance weather information may be information indicating at least one of temperature, humidity, wind speed, weather type, infrared intensity, or atmospheric pressure, every thirty minutes in the past. The performance amount-of-energy information may be an amount of generated electric power which the power generation apparatus 18 generated every thirty minutes in the past. The performance amount-of-energy information may be an amount of consumed electric power which was consumed in the office 30 every thirty minutes in the past. The performance amount-of-energy information may be an amount of electric power obtained from a difference between the amount of consumed electric power which was consumed in the office 30 every thirty minutes in the past and the amount of generated electric power which the power generation apparatus 18 generated every thirty minutes in the past.

The model generation unit 460 constructs the prediction model based on a relationship between performance weather information indicating a performance value of weather at each of a plurality of past time points and performance amount-of-energy information indicating a performance value of the amount of energy at each of the plurality of time points.

To describe generating of the first prediction model, the model generation unit 460 constructs the first prediction model by performing machine learning which uses the performance weather information and the performance amount-of-energy information with a magnitude which varies depending on whether a difference amount between an amount of energy output by the first prediction model when the performance weather information is input into the first prediction model and the performance value of the amount of energy corresponding to the performance weather information is larger or smaller than a predefined value. More specifically, the model generation unit 460 constructs the first prediction model by optimizing a goal function value which varies depending on whether the difference amount in question is larger or smaller than a predefined value. Specifically, the model generation unit 460 constructs the first prediction model by optimizing the goal function value which varies depending on whether the difference amount is positive or negative.

To describe generating of the second prediction model, the model generation unit 460 constructs the second prediction model, by performing machine learning which uses the performance weather information and the performance amount-of-energy information and of which goal function is a probability distribution function, such that the second prediction model further outputs the index value on distribution. The probability distribution function includes a parameter corresponding to the amount of energy at the predefined time point and a parameter corresponding to the index value on distribution. As an example, the parameter corresponding to the amount of energy at the predefined time point included in the probability distribution function may indicate an average value of the amount of energy. The parameter corresponding to the index value on distribution included in the probability distribution function may indicate a standard deviation.

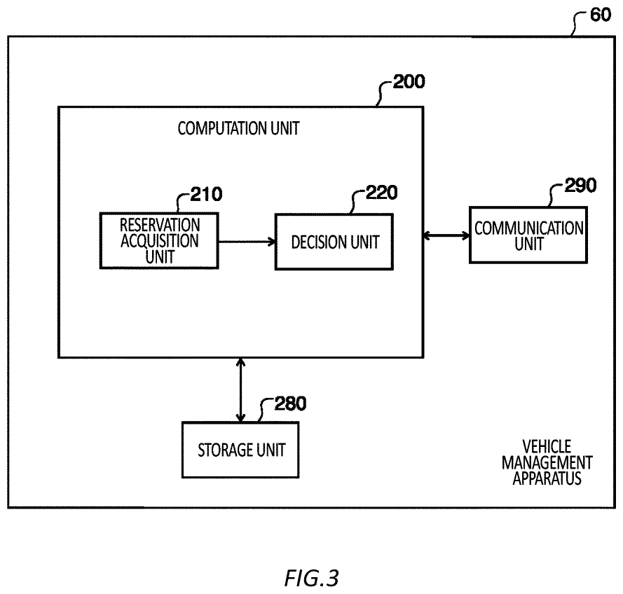

FIG. 3 illustrates an example of a system configuration of the vehicle management apparatus 60. The vehicle management apparatus 60 includes a computation unit 200, a storage unit 280, and a communication unit 290. The vehicle management apparatus 60 performs information processing for a usage plan of the vehicle 10. The vehicle management apparatus 60 functions as at least a part of an information processing apparatus that performs information processing for the usage plan of the vehicle 10.

The computation unit 200 performs control of the communication unit 290. The communication unit 290 is responsible for communication between the vehicle 10, the integrated management apparatus 50, and the terminal 22, for example. The computation unit 200 is embodied as an arithmetic processing unit including a processor. Each storage unit 280 is embodied to include a non-volatile storage medium. The computation unit 200 performs processing by using the information stored in the storage unit 280. The computation unit 200 may be embodied as a microcomputer including a CPU, a ROM, a RAM, an I/O, a bus, and the like. The vehicle management apparatus 60 may be embodied as a computer.

In the present embodiment, the vehicle management apparatus 60 shall be embodied as a single computer. However, in another embodiment, the vehicle management apparatus 60 may be embodied as a plurality of computers. At least some of functions of the vehicle management apparatus 60 may be implemented by one or more servers, such as a cloud server.

The computation unit 200 includes a reservation acquisition unit 210 and a decision unit 220. The reservation acquisition unit 210 acquires the reservation information to reserve a usage of the vehicle 10. For example, the reservation acquisition unit 210 acquires the reservation information transmitted by the terminal 22. The storage unit 280 stores the reservation information. The decision unit 220 acquires the reservation information from the storage unit 280, and devises the usage plan of the vehicle 10 based on the reservation information thus acquired.

The reservation information includes a time period for which the user 20 is scheduled to use the vehicle 10 to drive. The reservation information may include a time at which the user 20 is to start using the vehicle 10 and a time at which the user 20 is to finish using the vehicle 10. The reservation information may include information for designating a specific vehicle 10 which the user 20 is to use, among the plurality of vehicles 10. The decision unit 220 devises, based on the reservation information, an operation plan of the vehicle 10. The operation plan includes a time period for which the vehicle 10 is to be used.

The communication unit 290 transmits the operation plan to the integrated management apparatus 50. The communication unit 290 may further transmit at least a part of the reservation information to the integrated management apparatus 50. The communication unit 290, when the vehicle 10 which is to be used by the user is changed due to arbitration of competing reservations, may transmit a notification indicating that the vehicle 10 is changed, to the user for whom the vehicle 10 thus changed was reserved. As described below, the decision unit 220 decides, based on a result of the arbitration of the operation plan transmitted by the integrated management apparatus 50 and the operation plan, the usage plan of the vehicle 10.

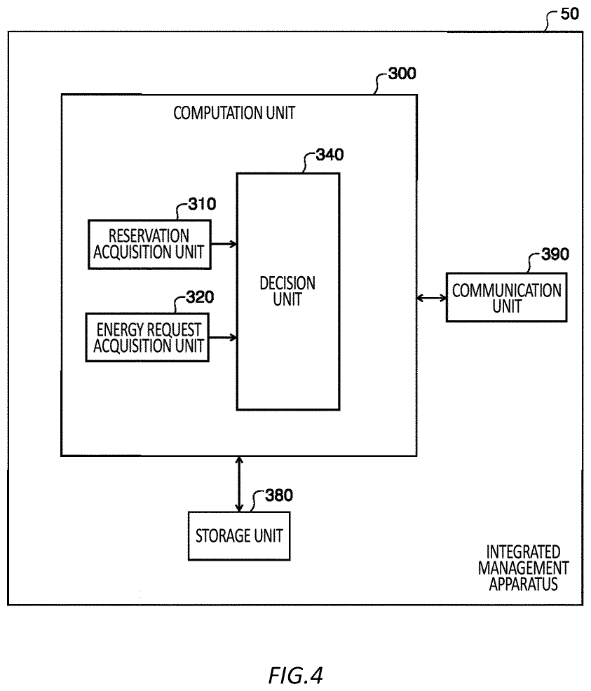

FIG. 4 illustrates an example of a system configuration of the integrated management apparatus 50. The integrated management apparatus 50 includes a computation unit 300, a storage unit 380, and a communication unit 390. The integrated management apparatus 50 performs information processing for the usage plan of the vehicle 10. The integrated management apparatus 50 functions as at least a part of an information processing apparatus that performs information processing for the usage plan of the vehicle 10.

The computation unit 300 performs control of the communication unit 390. The communication unit 390 is responsible for communication in the integrated management apparatus 50. The communication unit 390 is responsible for communication between at least the power control apparatus 140, the vehicle management apparatus 60, and the power control apparatus 40 and the integrated management apparatus 50. The computation unit 300 is embodied as an arithmetic processing unit including a processor. Each storage unit 380 is embodied to include a non-volatile storage medium. The computation unit 300 performs processing by using the information stored in the storage unit 380. The computation unit 300 may be embodied as a microcomputer including a CPU, a ROM, a RAM, an I/O, a bus, and the like. The integrated management apparatus 50 may be embodied as a computer.

In the present embodiment, the integrated management apparatus 50 shall be embodied to include a single computer. However, in another embodiment, the integrated management apparatus 50 may be implemented by a plurality of computers. At least some of functions of the integrated management apparatus 50 may be embodied to include one or more servers, such as a cloud server. In the present embodiment, the integrated management apparatus 50 and the vehicle management apparatus 60 may be embodied as a same computer or may be embodied as computers different from each other. All or at least some of the functions of the integrated management apparatus 50 and the vehicle management apparatus 60 may be implemented by the same computer.

The computation unit 300 includes a reservation acquisition unit 310, an energy request acquisition unit 320, and a decision unit 340.

The reservation acquisition unit 310 acquires information on the reservation information to reserve the usage of the vehicle 10. Specifically, the reservation acquisition unit 310 acquires information indicating the operation plan generated by the vehicle management apparatus 60.

The energy request acquisition unit 320 acquires energy request information on a request for energy that is to be provided from the vehicle 10. For example, the energy request acquisition unit 320 accepts the energy request information from the power control apparatus 40. The energy request information may include information indicating a requested amount of energy and information indicating a time period for which energy is requested. Information indicating an electricity plan decided by the power control apparatus 40 is an example of the energy request information.

The decision unit 340 decides, based on the information indicating the operation plan acquired by the reservation acquisition unit 310 and the energy request information acquired by the energy request acquisition unit 320, the usage plan of the vehicle 10. For example, the decision unit 340 decides, based on the information indicating the operation plan and the information indicating the electricity plan, a time period for which the vehicle 10 is to be used to drive and a time period for which the vehicle 10 is to be used to provide electric power to the office 30. For example, the decision unit 340 may decide the time period for which the vehicle 10 is to be used to drive and the time period for which the vehicle 10 is to be used to provide electric power by regarding a time period for which the vehicle 10 is not to be used to drive as a time period for which the vehicle 10 is able to be used to provide electric power for the office 30. When the time period for which the vehicle 10 is to be used to drive and the time period for which the vehicle 10 is to be used to provide electric power cannot be decided, the decision unit 340 performs arbitration of the operation plan and the electricity plan. For example, the decision unit 340 decides an adjustment amount of the time period for which the vehicle 10 is to be used to drive, and/or an adjustment amount of the time period for which the vehicle 10 is to be used to provide electric power, and transmits a result of the arbitration indicating the adjustment amounts thus decided to the vehicle management apparatus 60 and the power control apparatus 40. This allows the vehicle management apparatus 60, the power control apparatus 40, and the integrated management apparatus 50 to cooperate with each other to decide the usage schedule of the vehicle 10 based on an amount of energy at the predefined future time point predicted by the prediction unit 420 of the power control apparatus 40.

In the present embodiment, the description will focus on “electric power” as an example of “energy”. In the present embodiment, electric power exchange is an example of “energy exchange”. However, energy is not limited only to electric power. As an example, an embodiment that uses fuel such as hydrogen as an energy source, as a form of “energy”, can be employed.

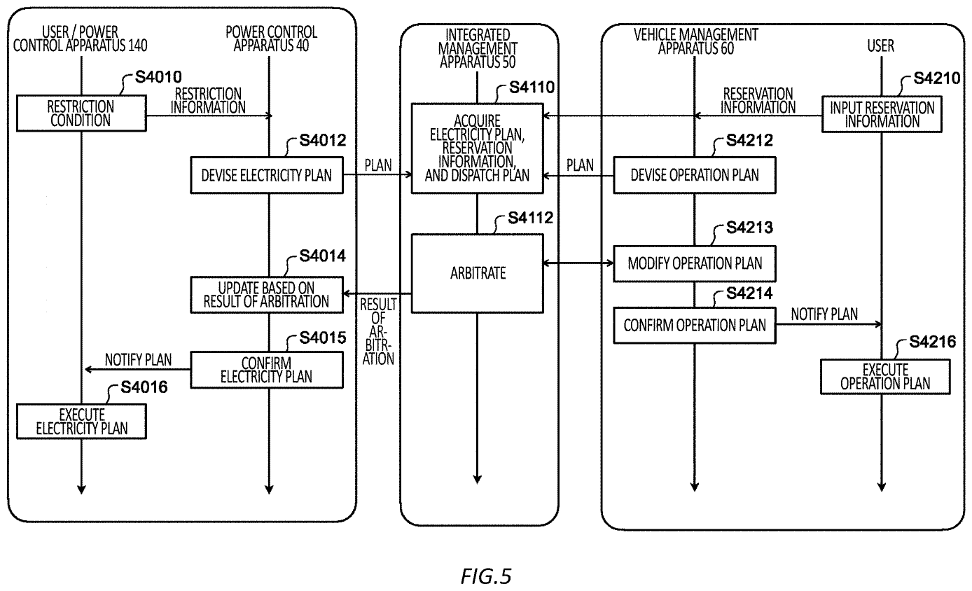

FIG. 5 illustrates an execution sequence of processing in a method performed by the power control apparatus 40, the integrated management apparatus 50, and the vehicle management apparatus 60. The processing in FIG. 5 represents processing from devising of an electricity plan and an operation plan on a particular date until various types of control are performed according to the plans thus devised. The devising of the electricity plan and the operation plan is performed on a day before the target particular date or at a relatively early time on the particular date.

As control for the power control apparatus 40, in S4010, at least one of a user of the power control apparatus 40 or the power control apparatus 140 sets a restriction condition on the electricity plan in the office 30 to notify the power control apparatus 40 thereof. The power control apparatus 140 may set the restriction condition in the office 30 so as to minimize the overall electricity cost in the office 31 and the office 30. The user is a person or a system that inputs information on power management into the power control apparatus 40 in the office 30. The restriction condition is a condition which becomes a restriction for devising of the electricity plan. The restriction condition may include a restriction that is required to meet the power demand. The restriction condition includes a predicted amount of electric power to be generated, a predicted amount of consumed electric power, and information on electricity charge, for example. The amount of electric power to be generated is an amount of electric power to be generated by the power generation apparatus 80, for example. The amount of electric power to be consumed is an amount of electric power to be consumed in the office 30. The electricity charge includes an electricity purchase price, an electricity selling price, and a monetary consideration obtained by reducing the amount of consumed electric power according to a demand response. The electricity purchase price is, for example, a condition related to an amount of money charged as a monetary consideration for power reception by the office 30 from the power network 90. The electricity selling price is, for example, a condition related to an amount of money obtained as a monetary consideration for power supply by the office 30 to the power network 90.

In S4012, the power control apparatus 40 devises an electricity plan for a target date in the office 30 based on restriction information. The electricity plan includes an amount of consumed electric power for each time frame over one day. The electricity plan defines how much electric power is consumed for each time frame in the office 30. The amount of consumed electric power for each time frame on the target date may be predicted from environmental information, such as weather information on the target date, and data of past performance. The electricity plan may include peak-shaving information for performing peak shaving. The peak-shaving information may include information indicating how much consumed electric power is to be suppressed during what time frame in the office 30. The peak-shaving information may include information indicating how much electric power is to be received from the outside during what time frame in the office 30.

The power control apparatus 40 may devise an optimal electricity plan in the office 30. For example, the power control apparatus 40 may devise an electricity plan so as to minimize the amount of electric power received from the power network 90 in the office 30. The power control apparatus 40 may devise an electricity plan so as to minimize the amount of money charged as a monetary consideration for power reception from the power network 90 received in the office 30. On condition that the contracted power in at least the office 30 is complied with, the power control apparatus 40 may devise an electricity plan so as to maximize an amount of money obtained as a monetary consideration for reducing the amount of consumed electric power in the office 30 according to the demand response in the office 30 or performing power supply to the power network 90. In this manner, the power control apparatus 40 devises the optimal electricity plan as the electricity plan on the target date in the office 30 based on the restriction condition. According to this electricity plan, an amount of electric power that needs to be received from the outside for each time frame on the target date is defined. The amount of electric power that needs to be received from the outside may be supplied from the battery 12 included in the vehicle 10 parked in the office 30. The power control apparatus 40 transmits the electricity plan thus devised to the integrated management apparatus 50.

As control for the vehicle management apparatus 60, in S4210, the user inputs reservation information on dispatch of the vehicle 10. The user is a person who uses the vehicle 10, a manager of the system, the system, or the like. The reservation information includes a condition that may become a restriction on devising of the operation plan. The reservation information includes a departure point, a destination, and a return point, and a departure time at the departure point, a return time and a departure time at the destination, and a return time to the return point, and the like, for example. The departure point and the destination define from which location to which location the vehicle 10 needs to drive. For the departure time at the departure point and the return time at the return point, a duration adjustment allowance may be set, which indicates a duration for which a change of the departure time and the return time can be allowed to be made. The reservation information input in S4210 is transmitted to the vehicle management apparatus 60 and also transmitted to the integrated management apparatus 50 through the vehicle management apparatus 60.

In S4212, the decision unit 220 of the vehicle management apparatus 60 devises an operation plan on the target date in the office 30 by aggregating the restriction conditions which has been notified of by the user 20. For example, the decision unit 220 decides the vehicle 10 which is to be used for transporting a person, a drive route of the vehicle 10, and a drive speed of the vehicle 10, so as to satisfy a transportation demand defined by the reservation information. The vehicle management apparatus 60 transmits the operation plan thus devised to the integrated management apparatus 50.

In S4110, the integrated management apparatus 50 accepts the electricity plan transmitted from the power control apparatus 40 as well as the reservation information and the operation plan transmitted from the vehicle management apparatus 60.

In S4112, the decision unit 340 of the integrated management apparatus 50 determines whether or not the electricity plan in the office 30 is satisfied if the vehicle 10 is operated according to the operation plan. For example, the operation plan defines a time period for which it is predicted that the vehicle 10 will exist in the office 30. The decision unit 340 determines that the electricity plan is satisfied if it is predicted that, in a time period for which the office 30 needs power supply from the outside, electric power can be received from the battery 12 included in the vehicle 10 existing at the office 30 for the time period in question.

When it is determined that the electricity plan cannot be satisfied if the vehicle 10 is dispatched according to the operation plan, the decision unit 340 determines how the operation plan should be modified so that the electricity plan can be satisfied. For example, the decision unit 340 decides an adjustment amount of the departure time and the return time of the vehicle 10 in the operation plan as a result of arbitration. The decision unit 340 may decide information that the vehicle 10 to be used by the user 20 defined by the operation plan is to be changed as the result of arbitration. The result of arbitration may include information indicating a time period for which the vehicle 10 is to be used to perform peak shaving in the office 30.

The integrated management apparatus 50 transmits the result of arbitration thus decided to the vehicle management apparatus 60. Upon receiving the result of arbitration from the integrated management apparatus 50, the decision unit 220 of the vehicle management apparatus 60 decides the usage plan of the vehicle 10 by modifying the operation plan devised in S4212 based on the result of arbitration (S4213). For example, the decision unit 220 modifies the operation plan so that the reservation information is satisfied based on the adjustment amount of the departure time and the return time received from the integrated management apparatus 50. The vehicle management apparatus 60 transmits a result of modifying the operation plan to the integrated management apparatus 50. The integrated management apparatus 50 and the vehicle management apparatus 60 repeat the processes in S4112 and S4213 to decide a performable operation plan. In S4213, the decision unit 220 decides the performable operation plan by deciding an operation route of the vehicle 10 and judging whether or not the vehicle 10 can return to the office 30 without running out of charge when causing the vehicle 10 to drive so that the departure time and the return time designated by the reservation information can be complied with, based on an SOC and the power consumption rate of the vehicle 10. Also, in S4112, considering an amount of electricity cost reduced in the office 30 when electric power exchange between the battery 12 and the office 30 according to the electricity plan thus decided is performed, and necessary operational cost of the vehicle 10 and utilization rate of the vehicle 10 when the vehicle 10 is operated according to the operation plan, the decision unit 340 may judge that the operation plan is performable, on condition that it is determined to be profitable in total.

When the operation plan is decided, the result of arbitration including the operation plan is transmitted to the power control apparatus 40. Upon receiving the result of arbitration from the integrated management apparatus 50, the power control apparatus 40 updates the electricity plan based on the result of arbitration (S4014), and notifies the user of the electricity plan confirmed by updating based on the result of arbitration (S4015). In S4016, the user and the power control apparatus 140 execute control according to the electricity plan thus notified of.

The vehicle management apparatus 60 confirms the operation plan finally decided in S4213 (S4214). When receiving a presentation request for the operation plan through the terminal 22 from the user 20, the vehicle management apparatus 60 notifies the user of the operation plan thus confirmed through the communication unit 290. In S4216, the user performs control of operating the vehicle 10 according to the operation plan thus notified of.

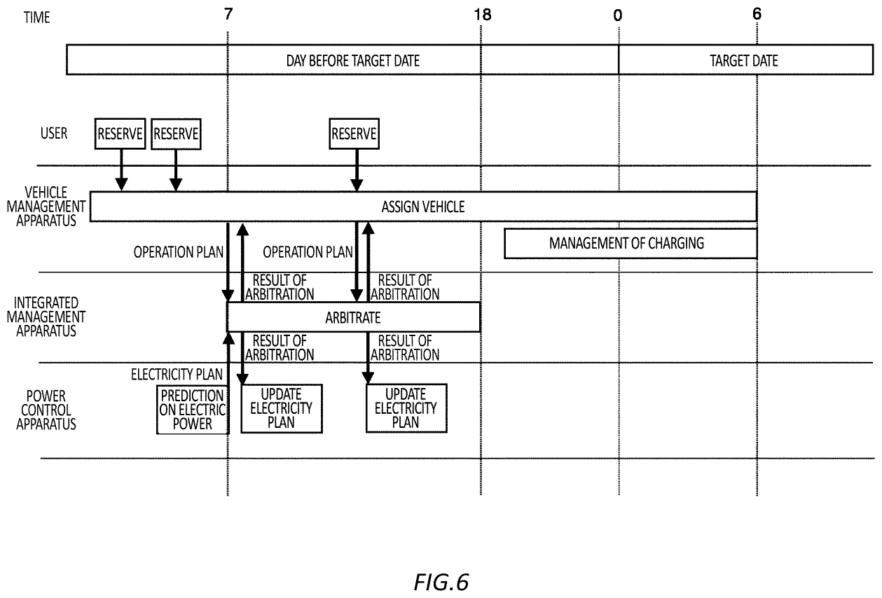

FIG. 6 schematically illustrates an overview of processing performed by the vehicle management apparatus 60, the integrated management apparatus 50 and the power control apparatus 40. In FIG. 6, a day on which the vehicle 10 is to be used is referred to as a “target date”.

The user 20 can make a reservation for the vehicle 10 at any timing prior to a timing to use the vehicle 10. When the user 20 inputs reservation information on the vehicle 10 by using the terminal 22, the terminal 22 transmits the reservation information to the vehicle management apparatus 60. The reservation information includes information indicating a time period for which the vehicle 10 is to be used to drive.

In the vehicle management apparatus 60, the decision unit 220, upon receiving the reservation information, decides an operation plan of the vehicle 10 by assigning the vehicle 10 to be used by the user 20 based on the reservation information and an operation plan of the vehicle 10 that has been already decided at the time point at which the reservation information is received. The vehicle management apparatus 60 transmits, at a predefined first timing, the operation plan which is decided by the decision unit 220, to the integrated management apparatus 50.

The power control apparatus 40 performs prediction on electric power on the target date. For example, the power control apparatus 40 predicts an amount of consumed electric power in the office 30 for each time frame on the target date, and an amount of electric power to be generated by the power generation apparatus 18, and decides, based on the amount of electric power thus predicted, a time period for which the vehicle 10 is to provide electric power to the office 30 and an amount of the electric power. The power control apparatus 40 transmits, at the first timing, an electricity plan indicating the time period for which the vehicle 10 is to provide electric power to the office 30 and the amount of the electric power, to the integrated management apparatus 50.

Although a case is illustrated where the “first timing” is 7 a.m. on a day before the target date in FIG. 6, the “first timing” is not limited to 7 a.m. on the day before the target date. The “first timing” may be a time other than 7 a.m. on the day before the target date. The “first timing” may be a timing prior to the day before the target date. The “first timing” may be a specific time on the target date.

The integrated management apparatus 50 performs arbitration based on the operation plan received from the vehicle management apparatus 60 and the electricity plan received from the power control apparatus 40, and transmits a result of the arbitration to the vehicle management apparatus 60 and the power control apparatus 40. For a time period from the first timing to a second timing, the integrated management apparatus 50 performs arbitration of the operation plan and the electricity plan every time the user 20 makes a new reservation.

At the second timing, the integrated management apparatus 50 finishes arbitrating, and the operation plan and the electricity plan are confirmed. The vehicle management apparatus 60 performs control of charging the vehicle 10 according to the operation plan thus confirmed. At least one of the vehicle management apparatus 60 or the power control apparatus 40 may cooperate, through the integrated management apparatus 50 for example, to decide information, such as a charge completion time and a goal SOC of the battery 12 that are needed for the electricity plan and the operation plan and to control charging of the vehicle 10 based on the information thus decided.

Although a case is illustrated where the “second timing” is 6 p.m. on the day before the target date in FIG. 6, the “second timing” is not limited to 6 p.m. on the day before the target date. The “second timing” may be a time other than 6 p.m. on the day before the target date. The “second timing” may be a timing prior to the day before the target date. The “second timing” may be a specific time on the target date.

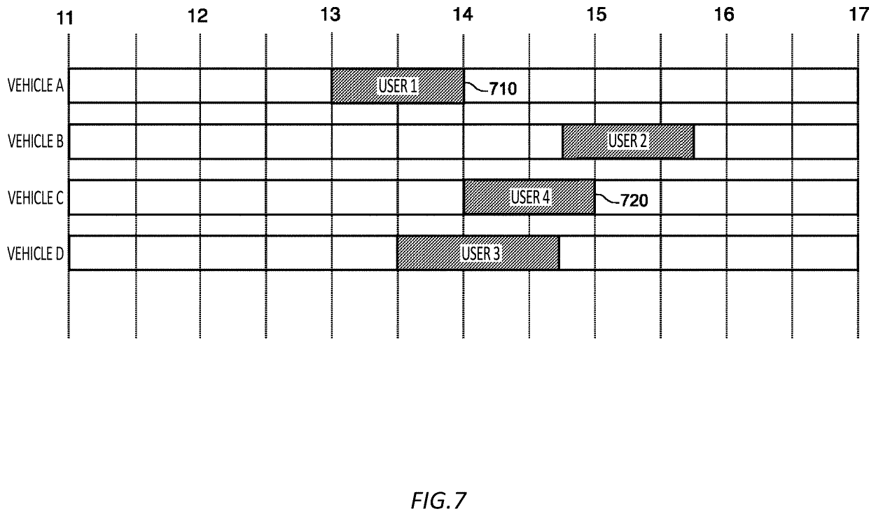

FIG. 7 schematically illustrates an example timetable for a usage of a vehicle 10 based on an operation plan. For example, in an example of FIG. 7, as indicated by reference numeral 710, it is reserved that a user 1 is to use “vehicle A” from 1 p.m. to 2 p.m. Further, it is reserved that a user 2 is to use “vehicle B” from 2:45 p.m. to 3:45 p.m. Further, it is reserved that a user 3 is to use “vehicle D” from 1:30 p.m. to 2:45 p.m. Further, as indicated by reference numeral 720, it is reserved that a user 4 is to use “vehicle C” from 2 p.m. to 3 p.m.

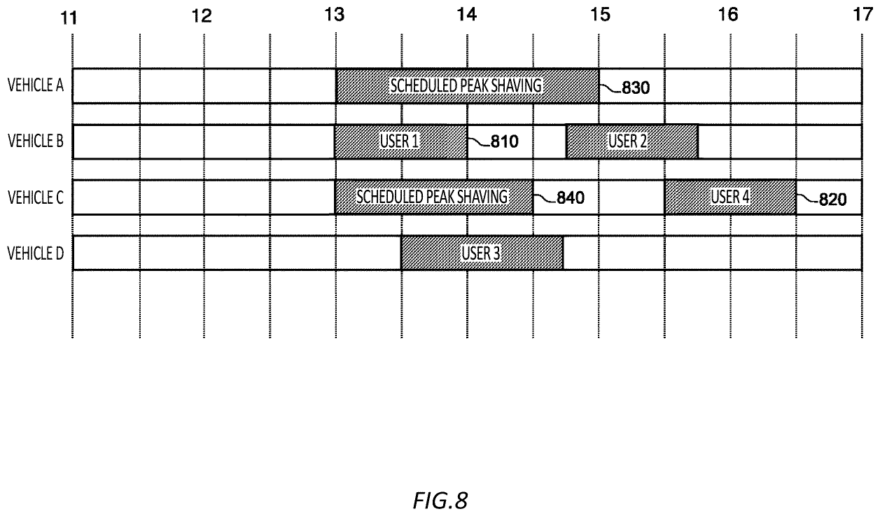

FIG. 8 schematically illustrates an example timetable for the usage of the vehicle 10 decided due to arbitration of an electricity plan and the operation plan.

As indicated by reference numeral 830 and reference numeral 840, arbitration by the integrated management apparatus 50 decides that vehicle A is to be used for peak shaving of the amount of consumed electric power in the office 30 for a time period from 1 p.m. to 3 p.m., and further that vehicle B is to be used for peak shaving of the amount of consumed electric power in the office 30 for a time period from 1 p.m. to 2:30 p.m. As a result, as shown by reference numeral 810, the vehicle 10 that “user 1” uses has been changed from “vehicle A” to “vehicle B”, and also as shown by reference numeral 820, a time period for which “user 4” uses “vehicle C” has been changed from a time period of 2 p.m. to 3 p.m. to a time period of 3:30 p.m. to 4:30 p.m. In this manner, in the system 5, the battery 12 of the vehicle 10 is used for peak shaving of the amount of consumed electric power in the office 30.

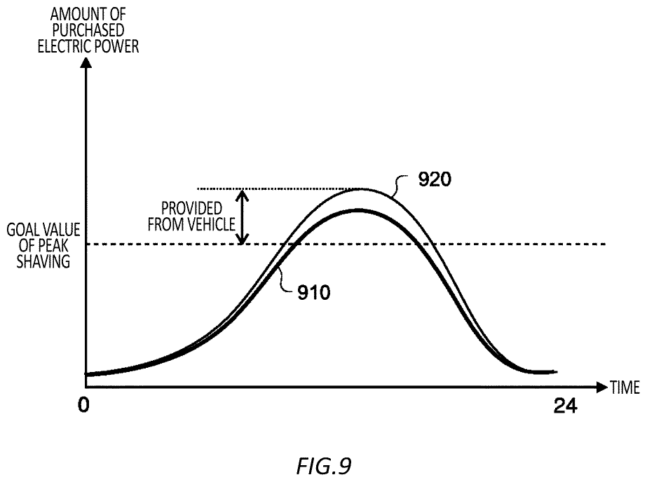

FIG. 9 illustrates a graph describing transitions of an amount of purchased electric power for the office 30 over one day. In the graph in FIG. 9, a horizontal axis represents time, and a vertical axis represents amount of purchased electric power. The amount of purchased electric power is the amount of electric power obtained by subtracting the amount of electric power to be generated by the power generation apparatus 18 from the amount of electric power to be consumed in the office 30.

Reference numeral 910 represents a transition of a performance value of the amount of purchased electric power over one day. Reference numeral 920 represents a transition of a predicted value of the amount of purchased electric power over one day.

In the system 5, the power control apparatus 40 decides an electricity plan to provide, from the battery 12 of the vehicle 10, an amount of electric power obtained from a difference between the predicted value of the amount of purchased electric power and a goal value of peak shaving. Accordingly, as the difference between the predicted value of the amount of purchased electric power and the goal value of peak shaving is larger, more vehicles 10 for peak shaving in the office 30 needs to be secured. Accordingly, it is desirable that a value close to the performance value is calculated as the predicted value of the amount of purchased electric power.

On the other hand, when the predicted value of the amount of purchased electric power is smaller than the performance value, an amount of electric power purchased from the outside of the office 30 increases, thereby increasing electricity cost. Therefore, in order to reduce electricity cost, it is desirable that the predicted value of the amount of purchased electric power is prevented from becoming smaller than the performance value.

Further, as a gap between the predicted value and the performance value of the amount of purchased electric power in the time axis direction becomes wider, a duration for which the vehicle 10 is secured to be used for peak shaving becomes longer, thereby shortening a duration for which the vehicle 10 may be used to operate. Therefore, it is desirable that the gap between the predicted value and the performance value of the amount of purchased electric power in the time axis direction is narrowed.

Accordingly, it is desirable that the prediction unit 420 calculates the predicted value of the amount of purchased electric power such that the gap between the predicted value of the amount of purchased electric power and the performance value of the amount of purchased electric power is narrowed, and calculates the predicted value of the amount of purchased electric power such that the predicted value of the amount of purchased electric power does not become smaller than the performance value.

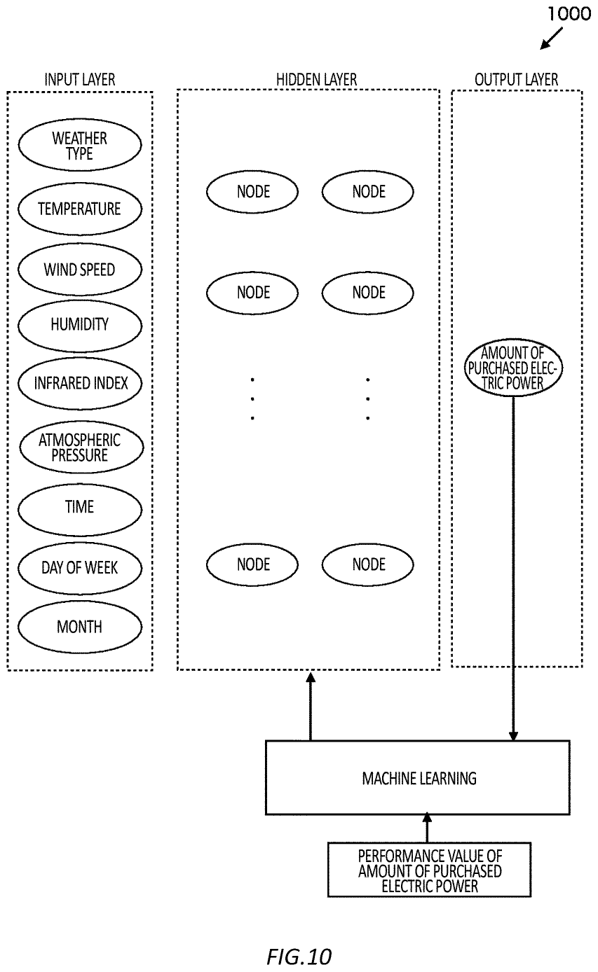

FIG. 10 conceptually illustrates processing in which the model generation unit 460 generates a prediction model. Here, a prediction model which predicts the amount of purchased electric power will be described.

The prediction model is constructed of a neural network 1000 including an input layer, a hidden layer, and an output layer. Information to be input into the input layer of the prediction model may include weather type, temperature, wind speed, humidity, infrared index, atmospheric pressure, time, day of week, month, and the like. Weather type, temperature, wind speed, humidity, infrared index, and atmospheric pressure are examples of weather information. Time, day of week, and month are examples of time-and-date information.

The prediction model outputs, when the weather information and the time-and-date information are input into the input layer of the prediction model, an amount of purchased electric power corresponding to the weather information and the time-and-date information. The model generation unit 460 performs machine learning based on the amount of purchased electric power output by the prediction model when the weather information and the time-and-date information are input into the input layer of the prediction model and the performance value of the amount of purchased electric power, and decides parameters of a plurality of nodes included in the hidden layer.

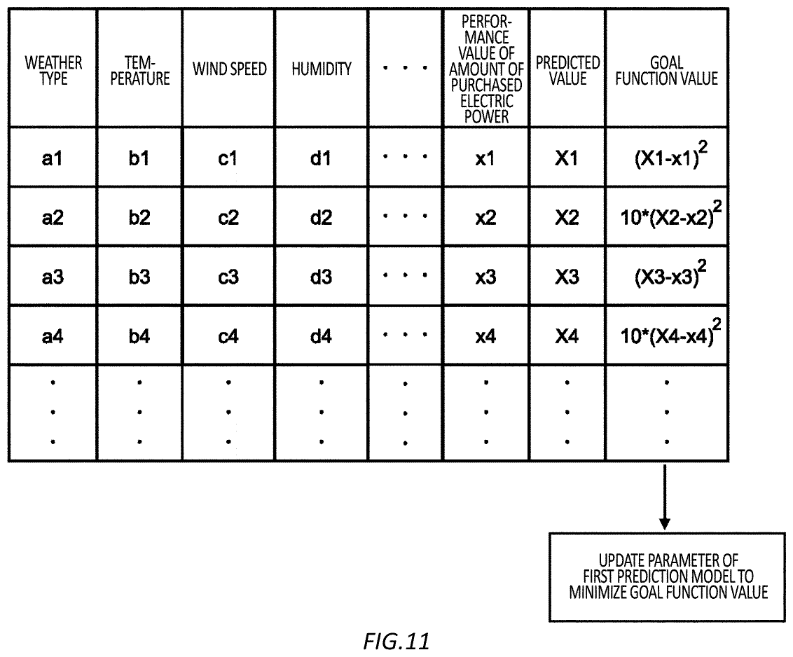

FIG. 11 illustrates a diagram for describing information that is used to generate the first prediction model. In FIG. 11, performance information is denoted as ai, bi, ci, di, . . . , xi, where i is a positive integer. i represents different past time points. ai, bi, ci, di, . . . represent the weather information and the time-and-date information input into the first prediction model, and xi represents the performance value of an amount of purchased electric power corresponding to ai, bi, ci, di, . . . .

Let X be a predicted value of an amount of purchased electric power output by the first prediction model when the weather information and the time-and-date information are input into the first prediction model, and let x be the performance value of an amount of purchased electric power corresponding to the weather information and the time-and-date information, then the model generation unit 460 uses ΣA×(X−x)² as the goal function. Here, Σ indicates summation over combinations of the weather information and the time-and-date information as well as the performance value of the amount of purchased electric power. A is a positive value. A is larger when X−x is negative than when X−x is positive. In FIG. 11, a case is illustrated in which A=10 when X−x is negative, and A=1 when X−x is positive. This allows the first prediction model to be constructed such that a probability that the predicted value of the amount of purchased electric power output by the first prediction model is smaller than the performance value of the amount of purchased electric power is lowered. This allows for preventing the amount of electric power purchased from the outside of the office 30 from increasing.

In the example of FIG. 11, a case has been illustrated in which A is larger when X−x is negative than when X−x is positive, but in another embodiment, the goal function may be set such that A is smaller when X−x is negative than when X−x is positive. This allows the first prediction model to be constructed such that a probability that the predicted value of the amount of purchased electric power output by the first prediction model is larger than the performance value of the amount of purchased electric power is lowered. This allows for preventing a number of at least one vehicle 10 to be secured for peak shaving in the office 30 from being too many.

In this manner, the model generation unit 460 performs machine learning such that a parameter of the first prediction model is updated to minimize the goal function. Thereby, the model generation unit 460 constructs the first prediction model by performing machine learning with a magnitude which varies depending on whether a difference amount between the amount of purchased electric power output by the first prediction model when the performance weather information is input into the first prediction model and the performance value of the amount of purchased electric power is positive or negative. This allows for managing risk, cost, and/or the like, according to various use applications and/or circumstances relating to the power demand.

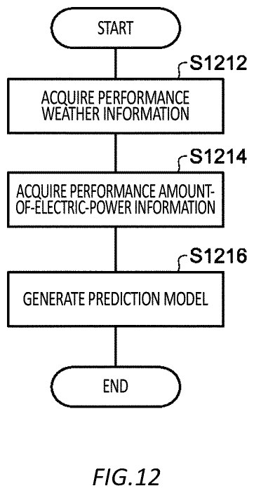

FIG. 12 is a flowchart for processing in which the power control apparatus 40 generates the prediction model. In S1212, the performance information acquisition unit 450 acquires performance weather information. For example, the performance information acquisition unit 450 acquires performance weather information on the office 30 from an external server which provides weather information in the past.

In S1214, the performance information acquisition unit 450 acquires performance amount-of-electric-power information. For example, the performance information acquisition unit 450 acquires an amount of consumed electric power of the electrical load provided in the office 30. In S1216, the model generation unit 460 generates a prediction model by using the performance weather information acquired in S1212 and the performance amount-of-electric-power information. For example, the model generation unit 460 generates the first prediction model using an approach described with reference to FIG. 10, FIG. 11, and the like.

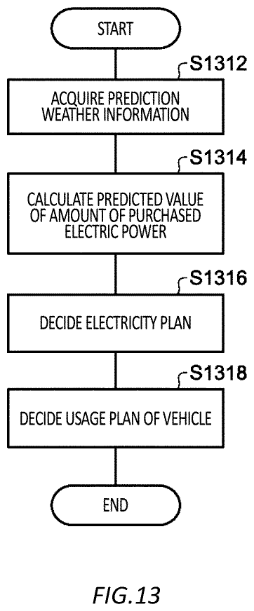

FIG. 13 is a flowchart for processing for deciding the usage plan of the vehicle 10 in the system 5. In S1312, the acquisition unit 410 acquires prediction weather information. For example, the acquisition unit 410 acquires the prediction weather information on the office 30 from an external server which provides weather information in the future.

In S1314, the prediction unit 420 calculates, based on the prediction weather information acquired in S1312 and the prediction model, a predicted value of the amount of purchased electric power. For example, the prediction unit 420 calculates, based on information output by the prediction model by inputting the prediction weather information acquired in S1312 and time-and-date information on a time and date to be calculated into the prediction model, the predicted value of the amount of purchased electric power. For example, the prediction unit 420 considers the information output by the first prediction model by inputting the prediction weather information acquired in S1312 and the time-and-date information on the time and date to be calculated into the first prediction model as the predicted value of the amount of purchased electric power.

In S1316, the decision unit 440 decides, based on the predicted value of the amount of purchased electric power, an electricity plan. Specifically, the decision unit 440 decides, based on the predicted value of the amount of purchased electric power and the goal value of peak shaving, the electricity plan.

In S1318, the usage plan of the vehicle 10 is decided. Specifically, the decision unit 340 of the integrated management apparatus 50 performs, based on the operation plan received from the vehicle management apparatus 60 and the electricity plan transmitted from the power control apparatus 40, arbitration of the operation plan and the electricity plan and transmits a result of the arbitration to the power control apparatus 40 and the vehicle management apparatus 60. The decision unit 220 of the vehicle management apparatus 60 decides, by updating the operation plan based on the result of the arbitration thus received, the usage plan for operation of the vehicle 10, and the decision unit 440 of the power control apparatus 40 decides, by updating the electricity plan based on the result of the arbitration thus received, the usage plan of the vehicle 10 for peak shaving in the office 30.

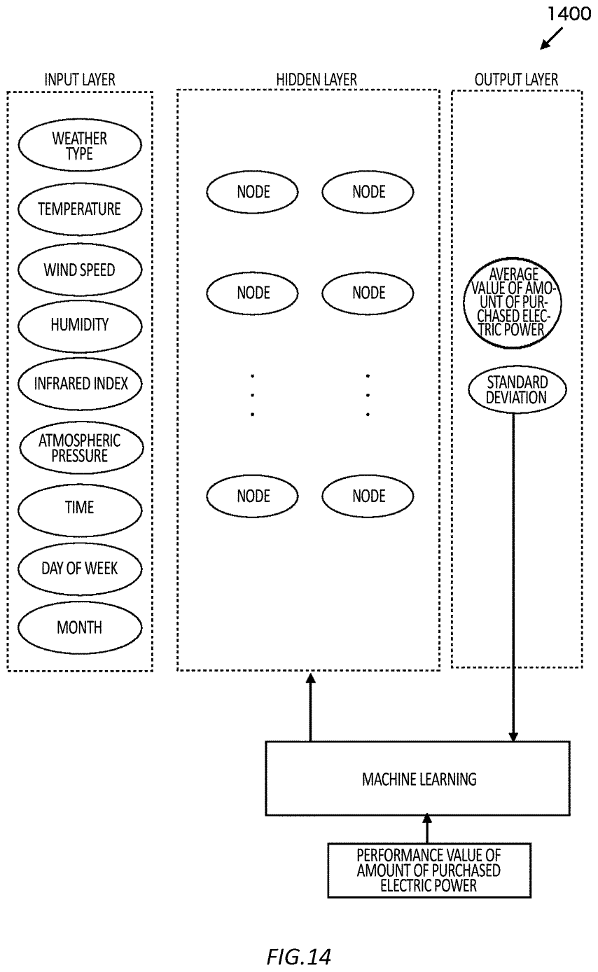

FIG. 14 conceptually illustrates another processing in which the model generation unit 460 generates the prediction model. Here, processing for generating the second prediction model will be described.

The second prediction model is constructed of a neural network 1400 including an input layer, a hidden layer, and an output layer. Information to be input into the input layer of the second prediction model may include weather type, temperature, wind speed, humidity, infrared index, atmospheric pressure, time, day of week, month, and the like. Weather type, temperature, wind speed, humidity, infrared index, and atmospheric pressure are examples of weather information. Time, day of week, and month are examples of time-and-date information.

The second prediction model outputs, when the weather information and the time-and-date information are input into the input layer of the second prediction model, information indicating an average value of the amount of purchased electric power and a standard deviation of the amount of purchased electric power in question corresponding to the weather information and the time-and-date information. The model generation unit 460 performs machine learning based on the average value and the standard deviation of the amount of purchased electric power output by the second prediction model when the weather information and the time-and-date information are input into the input layer of the second prediction model and the performance value of the amount of purchased electric power, and decides parameters of a plurality of nodes included in the hidden layer.

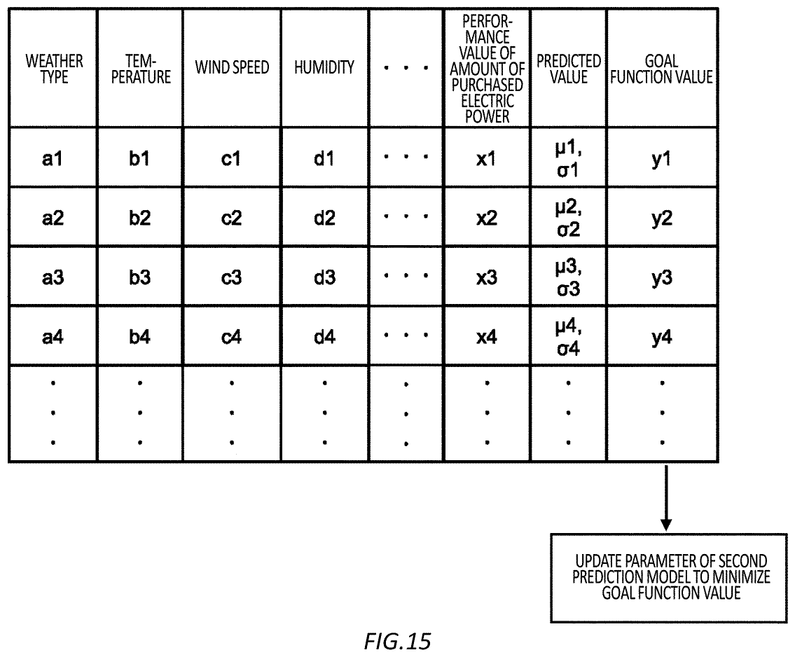

FIG. 15 illustrates a diagram for describing information that is used to generate the second prediction model. In FIG. 15, performance information is denoted as ai, bi, ci, di, . . . , xi, where i is a positive integer. i represents different past time points. ai, bi, ci, di, . . . represent the weather information and the time-and-date information input into the first prediction model, and xi represents the performance value of an amount of purchased electric power corresponding to ai, bi, ci, di, . . . μi and σi are pieces of information output by the second prediction model and represent the average value and the standard deviation of the amount of purchased electric power, respectively.

Let μ and σ be respectively the average value and the standard deviation of the amount of purchased electric power output by the second prediction model when the weather information and the time-and-date information are input into the second prediction model, and let x be the performance value of the amount of purchased electric power corresponding to the weather information and the time-and-date information, then the model generation unit 460 performs machine learning by using a summation of y, which is expressed by a formulation below, as the goal function.

$$y = - \frac{1}{\sqrt{2 π {σ}^{2}}} {e}^{- ( \frac{{( x - μ )}^{2}}{2 {σ}^{2}} )}$$

y is a probability density function with the average value and the standard deviation of the amount of purchased electric power as parameters. By generating the second prediction model by using the probability density function as the goal function such that the goal function is minimized, an expected average value μ of the amount of purchased electric power and an expected standard deviation σ of the amount of purchased electric power can be acquired, which correspond to the weather information input into the second prediction model.

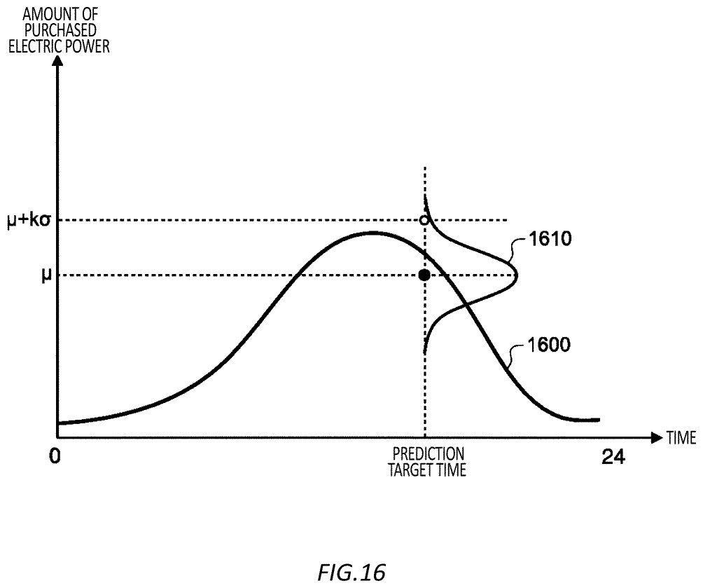

FIG. 16 illustrates a diagram for describing information output by the second prediction model. Reference numeral 1600 in FIG. 16 represents a transition of the performance value of the amount of purchased electric power, where a vertical axis represents amount of purchased electric power and a horizontal axis represents time.

The second prediction model outputs μ and σ by inputting prediction weather information at a prediction target time shown in FIG. 16 and time-and-date information into the second prediction model. μ represents an average value of an amount of purchased electric power at the prediction target time, and σ represents a standard deviation of an amount of purchased electric power at the prediction target time. Reference numeral 1610 represents a probability density function with μ and σ as parameters.

As an example, the prediction unit 420 calculates μ+kσ as the predicted value of the amount of purchased electric power. Here, k is a value that the prediction unit 420 is able to configure as appropriate. k=1, k=2, or k=3 may be possible. Configuring k to be a positive value allows for reducing a probability that the predicted value of the amount of purchased electric power becomes smaller than the performance value.

k may be configured to be a negative value. By configuring k to be a negative value, the probability that the predicted value of the amount of purchased electric power becomes smaller than the performance value becomes higher. Accordingly, when k is configured to be a negative value, while a probability that the amount of purchased electric power increases becomes higher, this brings about an advantage that the number of at least one vehicle 10 to be secured for peak shaving in the office 30 can be reduced. Accordingly, when the advantage of reducing the number of at least one vehicle 10 to be secured for peak shaving in the office 30 is significant, k can be configured to be a negative value.

The second prediction model allows for acquiring the average value and the standard deviation of the amount of purchased electric power. This allows the predicted value of the amount of purchased electric power to be decided flexibly according to the situation and/or risk.

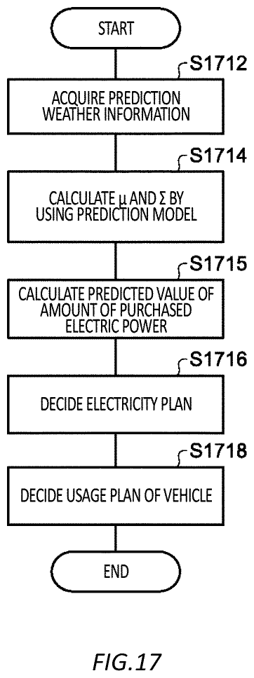

FIG. 17 is a flowchart for another processing for deciding the usage plan of the vehicle 10 in the system 5 by using the second prediction model. In S1712, the acquisition unit 410 acquires prediction weather information. For example, the acquisition unit 410 acquires the prediction weather information on the office 30 from an external server which provides weather information in the future.

In S1714, the prediction unit 420 calculates, by using the prediction weather information acquired in S1712 and the second prediction model, an average value μ and σ standard deviation σ of the amount of purchased electric power. For example, the prediction unit 420 calculates, by inputting the prediction weather information acquired in S1712 and time-and-date information on a time and date to be calculated into the second prediction model, the average value μ and the standard deviation σ of the amount of purchased electric power.

In S1715, the prediction unit 420 calculates a predicted value of the amount of purchased electric power. Specifically, as described with reference to FIG. 16 and the like, the prediction unit 420 calculates μ+kσ as the predicted value of the amount of purchased electric power.

In S1716, the decision unit 440 decides, based on the predicted value of the amount of purchased electric power, an electricity plan. In S1718, the usage plan of the vehicle 10 is decided. The description of processes in S1716 and S1718 is omitted because they are similar to processes described relating to S1316 and S1318.

The system 5 described above allows for predicting amount of purchased electric power appropriately. This allows for reducing, according to the situation in the office 30, a probability that a number of at least one vehicle 10 to be used for peak shaving in the office 30 is insufficient, and narrowing the gap between the predicted value and the performance value of the amount of purchased electric power.

With reference to FIG. 9 to FIG. 17, processes for each unit of the system 5 have been described focusing on an embodiment in which the amount of purchased electric power in the office 30 is predicted by using the prediction model. The amount of purchased electric power is an example of the amount of electric power calculated based on the amount of electric power to be generated by the power generation apparatus 18 and the amount of electric power to be consumed in the office 30. As another embodiment, an embodiment may be employed in which the amount of electric power to be generated by the power generation apparatus 18 is predicted by using the prediction model, and an embodiment may be employed in which the amount of electric power to be consumed in the office 30 is predicted by using the prediction model.

In the above description, an embodiment has been described, in which the vehicle management apparatus 60 and the integrated management apparatus 50 cooperate to implement functions as an information processing apparatus that performs information processing for the usage plan of the vehicle 10. However, as another embodiment, an embodiment may be employed in which functions of the vehicle management apparatus 60 and the integrated management apparatus 50 are implemented by one information processing apparatus.

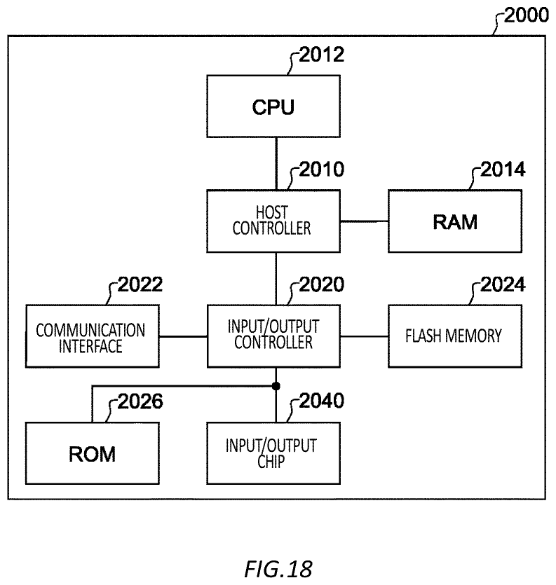

FIG. 18 illustrates an example of a computer 2000 in which a plurality of embodiments of the present invention may be entirely or partially embodied. A program installed on the computer 2000 may cause the computer 2000 to: function as the system 5 or each unit of the system 5 according to an embodiment, or an apparatus such as the power control apparatus 40, the integrated management apparatus 50, or the vehicle management apparatus 60 or each unit of the apparatus; perform an operation associated with the system or each unit of the system, or the apparatus or each unit of the apparatus; and/or perform a process or a step of the process according to an embodiment. Such a program may be executed by a CPU 2012 in order to cause the computer 2000 to execute a specific operation associated with some or all of the processing procedures and the blocks in the block diagrams described in the present specification.

The computer 2000, according to the present embodiment, includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates in accordance with programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 upon activation, and/or a program that depends on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, an HDMI (registered trademark) port.

A program is provided via a network or a computer-readable storage medium such as a CD-ROM, a DVD-ROM, or a memory card. The RAM 2014, the ROM 2026, or the flash memory 2024 is an example of a computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be constructed by realizing operations or processing of information in accordance with a use of the computer 2000.

For example, when a communication is executed between the computer 2000 and an external device, the CPU 2012 may execute a communication program loaded on the RAM 2014, and instruct the communication interface 2022 to execute communication processing based on processing described in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 and the like to be read into the RAM 2014, and execute various types of processing on the data in the RAM 2014. Next, the CPU 2012 writes back the processed data into the recording medium.

Various types of information, such as various types of programs, data, a table, and a database, may be stored in the recording medium and may be subjected to information processing. The CPU 2012 may execute, on the data read from the RAM 2014, various types of processing, including various types of operations, information processing, conditional judgement, conditional branching, unconditional branching, information search/replacement, or the like described in the present specification and designated by instruction sequences of the programs, and write back a result into the RAM 2014. In addition, the CPU 2012 may search for information in a file, a database, or the like in the recording medium. For example, when a plurality of entries each having an attribute value of a first attribute associated with an attribute value of a second attribute, is stored in the recording medium, the CPU 2012 may search for an entry having a designated attribute value of the first attribute that matches a condition from said plurality of entries, and read the attribute value of the second attribute stored in said entry, thereby obtaining the attribute value of the second attribute associated with the first attribute that satisfies a predefined condition.

The program or software module described above may be stored in a computer-readable storage medium on the computer 2000 or near the computer 2000. A recording medium, such as a hard disk or a RAM provided in a server system connected to a dedicated communication network or the Internet, can be used as the computer-readable storage medium. A program stored in the computer-readable storage medium may be provided to the computer 2000 via a network.

Programs that are installed in the computer 2000 and cause the computer 2000 to function as the power control apparatus 40 may cause, when executed by the computer, the computer 2000 to function as each unit of the power control apparatus 40 by working with the CPU 2012 or the like. The information processing described in these programs is read by the computer 2000, and the computer 2000 functions as each unit of the power control apparatus 40 which is a specific means in which software and the above-described various hardware resources cooperate. Then, when computation or processing of information according to the intended use of the computer 2000 in the present embodiment is realized by these specific means, the unique power control apparatus 40 according to the intended use is constructed.

Programs that are installed in the computer 2000 and cause the computer 2000 to function as the integrated management apparatus 50 may cause, when executed by the computer, the computer 2000 to function as each unit of the integrated management apparatus 50 by working with the CPU 2012 or the like. The information processing described in these programs is read by the computer 2000, and the computer 2000 functions as each unit of the integrated management apparatus 50 which is a specific means in which software and the above-described various hardware resources cooperate. Then, when a computation or processing of information according to the intended use of the computer 2000 in the present embodiment is realized by these specific means, the unique integrated management apparatus 50 according to the intended use is constructed.

The program installed in the computer 2000 to cause the computer 2000 to function as the vehicle management apparatus 60 may work on the CPU 2012 or the like to cause the computer 2000 to function as each unit of the vehicle management apparatus 60. The information processing described in these programs is read by the computer 2000 to function as each unit of the vehicle management apparatus 60 which is a specific means in which software and the above-described various hardware resources cooperate. Then, when computation or processing of information according to the intended use of the computer 2000 in the present embodiment is realized by these specific means, the unique vehicle management apparatus 60 according to the intended use is constructed.

Various embodiments have been described with reference to the block diagrams and the like. In the block diagrams, each block may represent (1) a step of a process in which an operation is executed, or (2) each part of the device having a role in executing the operation. A particular step and each part may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element or the like, such as a flip-flop, a register, a field-programmable gate array (FPGA), a programmable logic array (PLA), or the like.

The computer-readable storage medium may include any tangible device capable of storing instructions to be executed by an appropriate device, so that the computer-readable storage medium having instructions stored therein constitutes at least a part of a product including instructions which can be executed to provide means for executing processing procedures or operations designated in the block diagrams. An example of the computer-readable storage medium may include an electronic storage medium, a magnetic storage medium, an optical storage medium, an electromagnetic storage medium, a semiconductor storage medium, etc. A more specific example of the computer-readable storage medium may include a FLOPPY (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a BLU-RAY (registered trademark) disk, a memory stick, an integrated circuit card, or the like.

The computer-readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object oriented programming language such as SMALLTALK (registered trademark), JAVA (registered trademark), and C++, or the like, and a conventional procedural programming language such as a “C” programming language or a similar programming language.

The computer-readable instruction is provided to the processor or programmable circuit of programmable data processing apparatuses, such as a computer locally or via a local area network (LAN), a wide area network (WAN) such as the Internet, and the computer-readable instruction may be executed in order to provide means to execute the operations specified in the described processing procedure or block diagrams.

Here, the computer may be a computer such as a personal computer (PC), a tablet computer, a smartphone, a workstation, a server computer, or a general-purpose computer, or may be a computer system in which a plurality of computers are connected. Such a computer system in which a plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multitasking, each of the plurality of processors may execute a portion of each task piece by piece by performing task-switching for each time slice. In this case, which portion of one program each processor is responsible for executing dynamically changes. In addition, which portion of the program each of the plurality of processors is to execute may be statically defined by multiprocessor-aware programming.

While the present invention has been described by way of the embodiments, the technical scope of the present invention is not limited to the above-described embodiments. It is apparent to persons skilled in the art that various modifications or improvements can be made to the above-described embodiments. It is also apparent from the description of the claims that the embodiments to which such modifications or improvements are made may be included in the technical scope of the present invention.

Note that the operations, procedures, steps, and stages etc. of each process performed by a device, system, program, and method shown in the claims, specification, or diagrams can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

5: system;
10: vehicle;
12: battery;
18: power generation apparatus:
20: user;
22: terminal;
30, 31: office;
40, 41: power control apparatus;
50, 51: integrated management apparatus;
60, 61: vehicle management apparatus;
70: power consumer;
80: power generation apparatus;
90: power network;
140: power control apparatus;
180: server;
190: communication network;
200: computation unit;
210: reservation acquisition unit;
220: decision unit;
280: storage unit;
290: communication unit;
300: computation unit;
310: reservation acquisition unit;
320: energy request acquisition unit;
340: decision unit;
380: storage unit;
390: communication unit;
400: computation unit;
410: acquisition unit;
420: prediction unit;
440: decision unit;
450: performance information acquisition unit;
460: model generation unit;
480: storage unit;
490: communication unit;
1000, 1400: neural network;
2000: computer;
2010: host controller;
2012: CPU;
2014: RAM;
2020: input/output controller;
2022: communication interface;
2024: flash memory;
2026: ROM;
2040 input/output chip.

What is claimed is:

1. An information processing apparatus which performs information processing for predicting an amount of energy to be generated and/or consumed in connection with weather, comprising:
an acquisition unit which acquires prediction weather information at a predefined time point; and
a prediction unit which predicts, based on information output by a prediction model that takes the prediction weather information as input, and outputs at least an amount of energy at the predefined time point, the amount of energy at the predefined time point, wherein
the prediction model is constructed based on a relationship between performance weather information indicating a performance value of weather at each of a plurality of past time points and performance amount-of-energy information indicating a performance value of an amount of energy at each of the plurality of time points, and
the prediction model is
(i) constructed by performing machine learning which uses the performance weather information and the performance amount-of-energy information with a magnitude which varies depending on whether a difference amount between an amount of energy output by the prediction model when the performance weather information is input into the prediction model and the performance value of an amount of energy corresponding to the performance value of weather indicated by the performance weather information is larger or smaller than a predefined value, or
(ii) constructed, by performing machine learning which uses the performance weather information and the performance amount-of-energy information, to further output an index value on distribution of energy at the predefined time point.

2. The information processing apparatus according to claim 1, wherein
an amount of energy which the prediction unit predicts is an amount of electric power to be generated by a power generation apparatus which generates electric power from renewable energy, an amount of electric power to be consumed by a power consumer who is to consume the electric power generated by the power generation apparatus, or, an amount of electric power calculated based on at least one of the amount of electric power to be generated or the amount of electric power to be consumed.

3. The information processing apparatus according to claim 2, wherein
the prediction model is constructed based on a relationship between the performance weather information at an installation location of a particular power generation apparatus which generates electric power from renewable energy and the performance amount-of-energy information on the particular power generation apparatus.

4. The information processing apparatus according to claim 3, wherein
the amount of energy at the predefined time point output by the prediction model is an amount of electric power to be generated by the particular power generation apparatus, an amount of electric power to be consumed by the power consumer who is to consume the electric power generated by the particular power generation apparatus, or, an amount of electric power calculated based on at least one of the amount of electric power to be generated or the amount of electric power to be consumed.

5. The information processing apparatus according to claim 1, wherein
the prediction model is constructed by optimizing a goal function value which varies depending on whether the difference amount is larger or smaller than a predefined value.

6. The information processing apparatus according to claim 1, wherein
the prediction model is constructed by optimizing a goal function value which varies depending on whether the difference amount is positive or negative.

7. The information processing apparatus according to claim 1, wherein
the prediction model is constructed, by performing machine learning which uses the performance weather information and the performance amount-of-energy information and of which goal function is a probability distribution function, such that the prediction model further outputs the index value on distribution.

8. The information processing apparatus according to claim 7, wherein
the probability distribution function includes a parameter corresponding to the amount of energy at the predefined time point and a parameter corresponding to the index value on distribution.

9. The information processing apparatus according to claim 1, wherein
the prediction weather information includes at least one of temperature, humidity, wind speed, weather type, infrared intensity, or atmospheric pressure.

10. The information processing apparatus according to claim 9, wherein
the prediction model is a model into which at least one of date, time or day of week is further input.

11. The information processing apparatus according to claim 1, further comprising
a decision unit which decides, based on the amount of energy at the predefined time point predicted by the prediction unit, a usage schedule of an energy accumulation apparatus which accumulates energy.

12. The information processing apparatus according to claim 11, wherein
the energy accumulation apparatus is a vehicle which includes an energy accumulation unit which accumulates energy.

13. The information processing apparatus according to claim 11, wherein
the decision unit decides, based on a difference between the amount of energy at the predefined time point predicted by the prediction unit and a predefined goal amount of energy, the usage schedule.

14. The information processing apparatus according to claim 11, further comprising
a reservation acquisition unit which acquires reservation information to reserve a usage of the energy accumulation apparatus, wherein
the decision unit decides the usage schedule based on the amount of energy at the predefined time point predicted by the prediction unit and the reservation information.

15. The information processing apparatus according to claim 2, wherein
the prediction model is constructed by optimizing a goal function value which varies depending on whether the difference amount is larger or smaller than a predefined value.

16. The information processing apparatus according to claim 2, wherein
the prediction model is constructed by optimizing a goal function value which varies depending on whether the difference amount is positive or negative.

17. The information processing apparatus according to claim 2, wherein
the prediction model is constructed, by performing machine learning which uses the performance weather information and the performance amount-of-energy information and of which goal function is a probability distribution function, such that the prediction model further outputs the index value on distribution.

18. The information processing apparatus according to claim 2, wherein
the prediction weather information includes at least one of temperature, humidity, wind speed, weather type, infrared intensity, or atmospheric pressure.

19. An information processing method for predicting an amount of energy to be generated and/or consumed in connection with weather, comprising:
acquiring prediction weather information at a predefined time point; and
predicting, based on information output by a prediction model that takes the prediction weather information as input and outputs at least an amount of energy at the predefined time point, the amount of energy at the predefined time point, wherein
the prediction model is constructed based on a relationship between performance weather information indicating a performance value of weather at each of a plurality of past time points and performance amount-of-energy information indicating a performance value of an amount of energy at each of the plurality of time points, and
the prediction model is
(i) constructed by performing machine learning which uses the performance weather information and the performance amount-of-energy information with a magnitude which varies depending on whether a difference amount between an amount of energy output by the prediction model when the performance weather information is input into the prediction model and the performance value of an amount of energy corresponding to the performance value of weather indicated by the performance weather information is larger or smaller than a predefined value, or
(ii) constructed, by performing machine learning which uses the performance weather information and the performance amount-of-energy information, to further output an index value on distribution of energy at the predefined time point.

20. A generation method of a prediction model for predicting an amount of energy to be generated and/or consumed in connection with weather, comprising:
acquiring performance weather information, which is a performance value of weather at each of a plurality of past time points and the performance amount-of-energy information, which is a performance value of amount of energy at each of the plurality of time points in the past; and
constructing the prediction model by performing machine learning which uses the performance weather information and the performance amount-of-energy information with a magnitude which varies depending on whether a difference amount between an amount of energy output by the prediction model when the performance weather information is input into the prediction model and the performance value of an amount of energy corresponding to the performance weather information is larger or smaller than a predefined value.
